(19) United States
(12) Patent Application Publication
(10) Pub. No.: US 2007/0198886 A1
(43) Pub. Date: Aug. 23, 2007

(54) Controller of electronic device, bus control device

(75) Inventor: Takeshi Saito, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION, Tokyo (JP)

(21) Appl. No.: 11/656,965

(22) Filed: Jan. 24, 2007

(30) Foreign Application Priority Data
Jan. 24, 2006 (JP) 2006-015151

(51) Int. Cl. H04L 1/18

(52) U.S. Cl. 714/749

(57) ABSTRACT

Processing ability can be easily decreased in a processor connected by a bus to a device that is a bus master. A controller of an electronic device has a processor and a bus controller that is the bus master of the processor, the bus controller including a mode determining section that determines mode based on a state of the processor, and a performance controller that, for a prescribed mode, inserts a wait time in an acknowledgement signal to be output to the processor.

The entire disclosure of Japanese Patent Applications Nos. 2006-15151 filed Jan. 24, 2006 is expressly incorporated by reference herein.

### BACKGROUND

1. Technical Field

The present invention relates to bus control between devices, and in particular, to technology by which a device on a bus master side lowers performance of a device on a slave device side.

2. Related Art

For a controller of an electronic device provided with a central processing unit (CPU) and a memory control device, there are configurations in which bus control between the CPU and the memory control device is performed on a memory control device side.

In such configurations, since the memory control device functions as a bus master of the CPU, for example, in cases in which the CPU requests data to be read from memory connected to the memory control device, the CPU outputs, to the memory control device, a request signal, together with a command signal indicating that this is a read instruction, and a read address signal.

When the address signal is properly received, the memory control device returns an address acknowledgement signal to the CPU. After that, when the memory control device obtains data that is to be read from the memory, the data is outputted to the CPU, and a data acknowledgement signal is outputted to notify the CPU that the data is ready. In this way, the CPU can read the requested data from the memory.

Furthermore, in cases in which the CPU requests data to be written to the memory that is connected to the memory control device, the CPU outputs, to the memory control device, a request signal, together with a command signal indicating that this is a write instruction, and a write address signal.

When the address signal is properly received, the memory control device returns an address acknowledgement signal to the CPU. The CPU, to which the acknowledgement signal has been returned, outputs a writing data signal.

When the data signal is properly received, the memory control device returns the data acknowledgement signal and performs memory access. In this way, the CPU can write the data requested to the memory.

Conventionally, when the address signal is properly received, the memory control device immediately returns the address acknowledgement signal to the CPU, and when the data signal is properly received and data to be outputted is ready, immediately returns the data acknowledgement signal to the CPU.

By carrying out this type of control, waiting time of the CPU is lessened, performance of the CPU is raised, and the CPU can realize maximum processing ability.

However, there are cases in which it is desired to reduce the processing ability of a processor such as a CPU, for example, when, due to some cause, the temperature of the processor rises abnormally, when it is desired to reduce power, or the like.

In these types of cases, slowing of the clock of the processor may be considered, but control and configuration to do so are complicated.

### SUMMARY

An advantage of some aspects of the invention includes the fact that processing ability of a processor connected by a bus to a device, which is a bus master, can be easily reduced.

In order to solve the abovementioned problems, according to a first aspect of the present invention, a controller of an electronic device comprises: a processor, and a bus controller that is a bus master of the processor, wherein the bus controller includes a mode determining section that determines mode, based on a state of the processor, and a performance control section that, for a prescribed mode, inserts a wait time in an acknowledgement signal to be output to the processor.

Since the processor is in a waiting state until the acknowledgement signal is returned, performance decreases.

In order to solve the abovementioned problems, according to a second aspect of the present invention, a bus controller, which is a bus master of a processor, comprises: a mode determining section that determines mode based on a state of the processor, and a performance control section that, for a prescribed mode, inserts a wait time in an acknowledgement signal to be output to the processor.

In the present aspect, since the processor is in a waiting state until the acknowledgement signal is returned, performance decreases.

Here, the mode that is determined may be a mode related to the temperature of the processor, and the prescribed mode may be a mode indicating that the temperature has become high.

In cases in which the temperature rises, by inserting the wait time into the acknowledgement signal, the performance decreases, and heat generation in the processor can be curtailed.

The acknowledgement signal may include at least one of: an address acknowledgement signal and a data acknowledgement signal.

In order to solve the abovementioned problems, according to a third aspect of the present invention, a printer controller, which outputs image data to a print engine, comprises: a CPU, and a memory control device that is a bus master of the CPU, wherein the memory control device includes a mode determining section that determines mode in accordance with a temperature state of the CPU, and a performance controller that, for a mode indicating that the temperature state of the CPU is high, inserts and outputs a wait time to an acknowledgement signal for the CPU.

In these cases, so that print processing is not halted, the wait time is at least within a time in which the CPU can generate the image data that is requested by the print engine.

### BRIEF DESCRIPTION OF THE DRAWINGS

FIG. 1 is a block diagram showing an outline of a configuration of a controller installed in a printer;

FIG. 2 is a flow diagram explaining mode switch processing of a CPU performance controller;

FIG. 3 is a timing diagram showing processing of the CPU performance controller for normal performance mode;

FIG. 4 is a timing diagram showing processing of the CPU performance controller for reduced performance mode; and

FIG. 5 is a timing diagram showing processing of the CPU performance controller for reduced performance mode.

### DESCRIPTION OF EXEMPLARY EMBODIMENTS

An embodiment of the present invention will be explained, referring to the figures. In the present embodiment, an example is explained in which the present invention is applied to a memory control device provided in a controller installed in a printer. In the present embodiment, a CPU and a memory are connected to the memory control device, and the memory control device performs control with regard to bus control between the memory control device and the CPU. That is, the memory control device functions as a bus master, and the CPU functions as a slave.

However, the present invention is not limited to this type of memory control device, and can be applied widely to devices that control a bus to other devices.

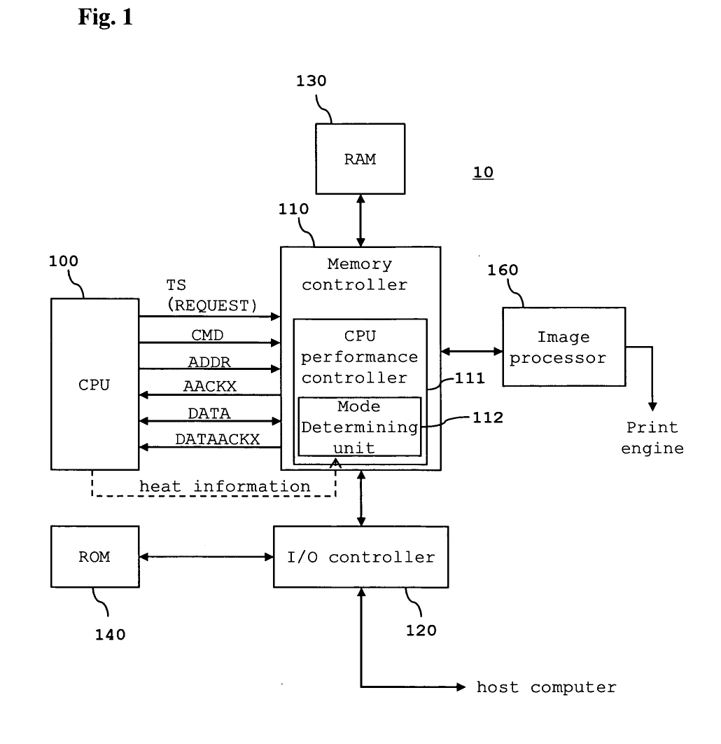

FIG. 1 is a block diagram showing an outline of a configuration of a controller 10 installed in a printer.

As shown in this figure, the controller 10 is provided with the CPU 100, the memory control device 110, an Input/Output (I/O) controller 120, a RAM 130, a ROM 140, and an image processor 160.

The CPU 100 is a processing device that controls various types of processing for the printer. The memory control device 110 connected by a bus to the CPU 100 is a device which performs access processing for the connected RAM 130, processing to supply image data to the image processor 160, and the like.

The RAM 130 is a memory module which temporarily stores a program, data and the like. The ROM 140 is a memory module which stores a program and the like, in a non-volatile way.

By performing image processing for color conversion and the like, on the supplied image data, the image processor 160 generates video data, to be supplied to the print engine, which is not shown in the figure.

The I/O device 120 is a device which performs access processing for the ROM 140 that is connected by a bus, and control processing for an external interface (I/F) in order to connect with a host computer or the like.

In the present embodiment, a bus between the CPU 100 and the memory control device 110 includes a TS (REQUEST) signal line, a CMD signal line, an ADDR signal line, and AACKX signal line, a DATA signal line and a DATAACKX signal line.

The TS signal line constitutes a request start signal sent from the CPU 100 to the memory control device 110, and by this signal a bus cycle starts between the CPU 100 and the memory control device 110.

The CMD signal indicates processing content of the request from the CPU 100. Here, for simplicity, the processing contents are taken as either data read from the RAM 130, or data written to the RAM 130. Clearly, there is no limitation to this.

The ADDR signal line sends data from the CPU 100 to the memory control device 110, and indicates a data reading address or a data writing address.

The AACKX signal line indicates that the memory control device 110 has properly received an address.

The DATA signal line indicates data written to the RAM 130 (data writing time), or data read from the RAM 130 (data reading time).

The DATAACKX indicates that the memory control device 110 has properly received data (data writing time), or that data that is to be read is ready (data reading time).

In the present embodiment, the memory control device 110 is provided with a CPU performance controller 111 that controls performance of the CPU 100. With regard to the CPU performance of the CPU 100, the CPU performance controller 111 switches between a normal performance mode and a reduced performance mode. Here, the normal performance mode is a mode in which the CPU 100 exhibits adequate processing ability, as is usual, and the reduced performance mode is a mode in which an increase in temperature of the CPU 100 is curtailed and consumed power is reduced, by going as far as reducing the performance of the CPU 100.

More specifically, in the normal performance mode, the memory control device 110 is a mode in which, as is usual, when a state in which a signal can be sent to the CPU 100 occurs, the AACKX signal or the DATAACKX signal is immediately outputted. On the other hand, the reduced performance mode is a mode in which the AACKX signal or the DATAACKX signal is not immediately returned to the CPU 100 even if the state is such that a signal can be sent, but the CPU 100 is put in standby, by inserting a wait period. That is, by making the CPU 100 stand-by, the performance of the CPU 100 is reduced, increase in temperature is curtailed, and the consumed power is reduced.

In the present embodiment, mode switching from the normal performance mode to the reduced performance mode is carried out when heat information concerning the CPU 100 main unit or vicinity thereof is obtained and the temperature thereof exceeds a threshold. In order to perform this determination, the memory control device 110 is provided with a mode determining unit 112. The heat information concerning the CPU 100 main unit or the vicinity thereof may be obtained by software or by hardware.

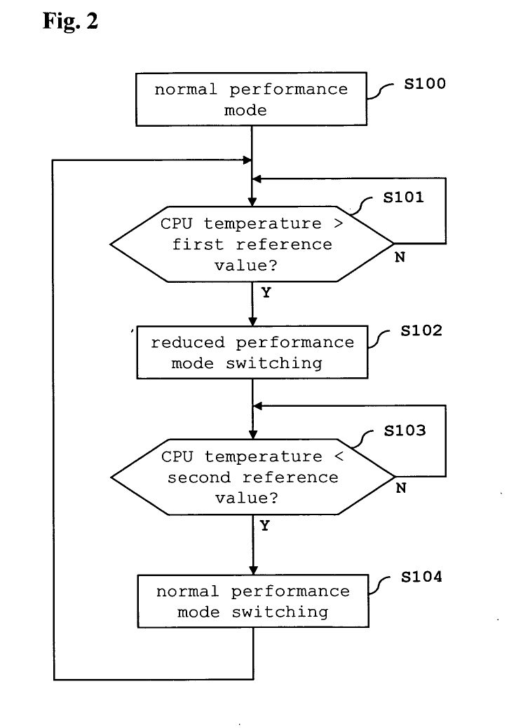

Next, an explanation of mode switch processing of the CPU performance controller 111 in the present embodiment will be given, referring to the flow diagram of FIG. 2. Moreover, when the mode is switched, and, for example, a mode setting register is arranged inside the CPU performance controller, the content thereof is rewritten.

During operation of the printer, a default state is one with the normal performance mode. In this way, the CPU 100 can exhibit adequate performance. During this time, the mode determining unit 112 determines whether or not the temperature of the CPU 100 has exceeded a first reference value decided in advance (step S101). As described above, the temperature of the CPU 100 can be obtained by measuring directly or indirectly.

If, due to some cause, the temperature of the CPU 100 exceeds the first reference value (Y in step S101), the CPU performance controller 111 switches to the reduced performance mode (step S102). As described above, this mode is a mode in which the performance of the CPU 100 is decreased, and thus the heat increase of the CPU 100 can be curtailed, so that the power consumption can be reduced.

In cases in which the temperature of the CPU 100 becomes less than a second reference value decided in advance, as a result of reducing the performance (Y in step S103), the CPU performance controller 111 switches to the normal performance mode (step S104). In this way, the CPU 100 can exhibit an adequate performance.

Furthermore, optimum values for the first reference value and the second reference value can be decided experimentally, and in order to prevent frequent switching of mode, provision of a hysteresis property is desirable.

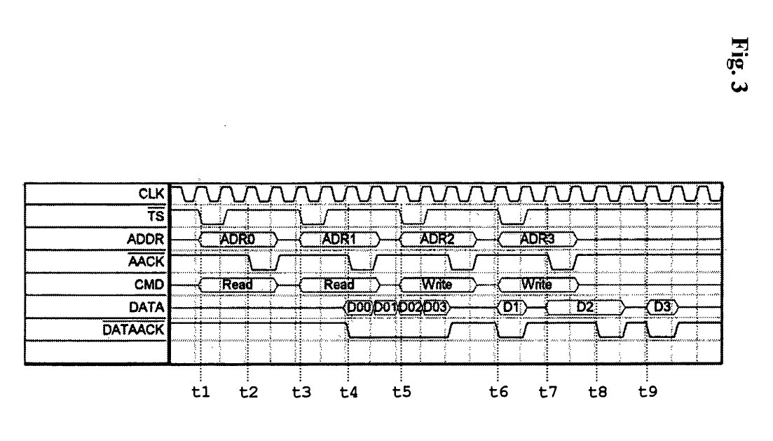

Next, an explanation is given concerning processing of the CPU performance controller 111 in the normal performance mode and the reduced performance mode, making reference to timing diagrams in FIG. 3 to FIG. 5. Furthermore, in the reduced performance mode, there are cases in which it is possible to insert a wait into AACKX that is the address control signal, and cases in which it is possible to insert a wait into DACKX that is the data control signal line. Clearly, both of these situations together are possible.

FIG. 3 is a timing diagram showing processing of the CPU performance controller 111 for the normal performance mode.

The example in this figure shows cases in which an address (ADR0) read command, an address (ADR1) read command, a write command of data (D2) to an address (ADR2), and a write command of data (D3) to an address (ADR3), from the CPU 100 to the memory control device 110, are performed continuously.

First, at t1 the CPU 100 outputs the TS signal, and exhibits a read command by a CMD signal, to give an instruction to the ADR0 by an ADDR signal.

When the ADR0 instruction is properly received, the CPU performance controller 111 immediately sends the AACKX signal to the CPU 100 (t2).

Thereupon, in order to made a subsequent read command, the CPU 100 outputs the TS signal, at t3, and shows a read command by the CMD signal, to instruct the ADR1 by the ADDR signal. With regard to this instruction, the CPU performance controller 111 immediately sends the AACKX signal to the CPU 100 (t4).

On the other hand, when data indicated by the ADR0 is obtained, the CPU performance controller 111 immediately outputs the DATAACKX signal, and also sequentially outputs data “D00”, “D01”, “D02”, “D03”, obtained by the DATA signal (t4).

In the same way, when data indicated by the ADR1 is obtained, the DATAACKX signal is immediately outputted, and the data “D1” obtained by the DATA signal is outputted (t6).

When the AACKX signal indicating that the ADR1 command has been properly received at t4 is received, the CPU 100 outputs the TS signal, and also exhibits a write command by the CMD signal, to instruct the ADR2 by the ADDR signal (t5).

When reading of D1 is finished at t6, D2, which is write data at t7, is outputted.

When the D2 is properly received, the CPU performance controller 111 immediately returns the DATAACKX signal (t8). When this DATAACKX signal is received, the CPU 100 outputs D3 that is subsequent write data, and when D3 is properly received, the CPU performance controller 111, immediately returns the DATAACKX signal (t9).

In this way, in the normal performance mode, when the CPU performance controller 111 properly receives an address signal or a data signal from the CPU 100, by immediately returning the ACK signal, the performance of the CPU 100 is adequately utilized.

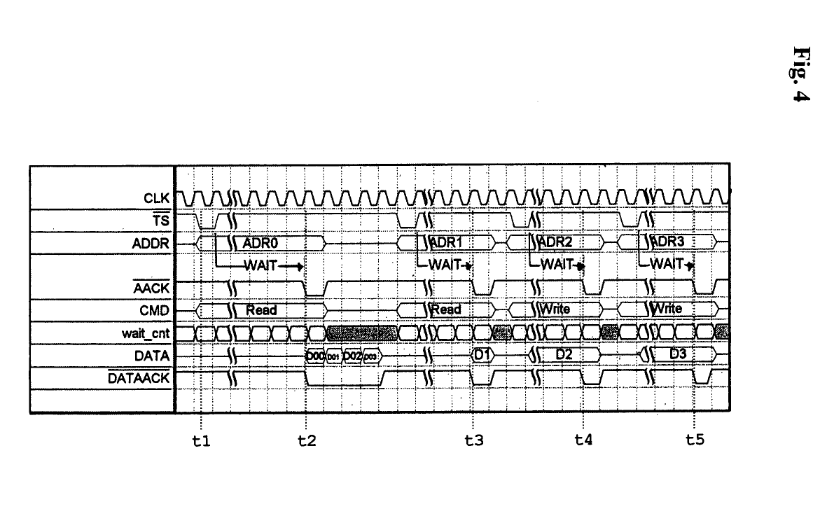

FIG. 4 is a timing diagram showing processing of the CPU performance controller 111 for the reduced performance mode. The figure shows an example in cases in which a wait is inserted to the AACKX that is an address control signal.

Similar to FIG. 3, the present figure shows cases in which an address (ADR0) read command, an address (ADR1) read command, a write command of data (D2) to an address (ADR2), and a write command of data (D3) to an address (ADR3), from the CPU 100 to the memory control device 110, are performed continuously.

Here, an explanation is given focusing on difference from the normal performance mode.

In the normal performance mode, at t2 in FIG. 3, when the ADR0 instruction is received normally, the CPU performance controller 111 immediately sends the AACK signal to the CPU 100.

However, in the reduced performance mode in which a wait is inserted into the AACKX, a prescribed wait period is inserted from a point in time when the ADR0 instruction is properly received, and the AACK signal is outputted (t2 in FIG. 4).

In the same way, also in cases in which ADR1, ADR2, and ADR3 are properly received, the CPU performance controller 111 does not immediately output the AACK signal, but inserts a prescribed wait period, and outputs the AACK signal (t3, t4 and t5).

Since the CPU 100 is in a waiting state until the AACK signal is returned, the performance is reduced. In this way, heat generation is curtailed, and the temperature of the CPU 100 is reduced.

Furthermore, the prescribed waiting period can be decided according to a property of the electronic device. For example, in cases in which a printer is used as an electronic device, as in the present embodiment, the CPU 100 can at least have a wait period sufficient for generation of image data requested by a print engine. Furthermore, the wait period may be dynamically varied according to the temperature, the temperature rise, and the like, of the CPU 100.

Moreover, the wait period can be measured by providing a counter in the CPU performance controller 111 and counting the number of clock units corresponding to a prescribed wait period (Wait_cnt in the figure).

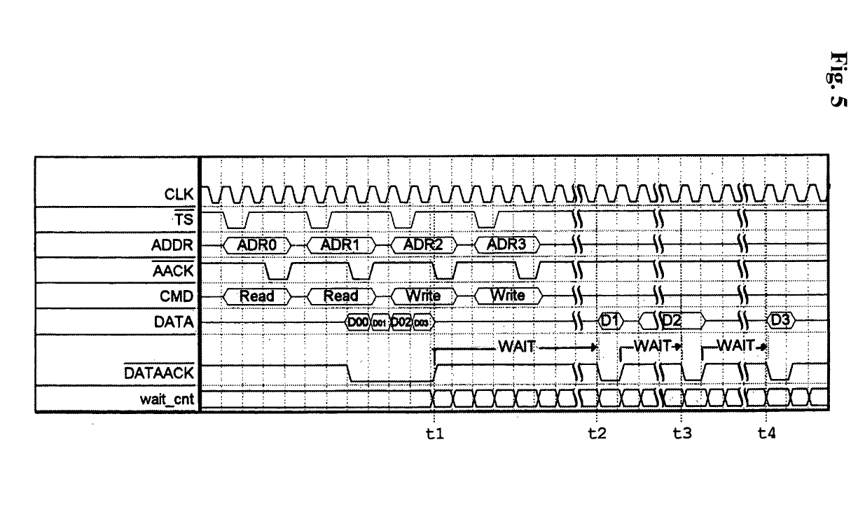

FIG. 5 is a timing diagram showing processing of the CPU performance controller 111 for reduced performance mode. The figure shows an example of cases in which a wait is inserted into the DATAACKX that is a data control signal.

Similar to FIG. 3, the present figure shows cases in which an address (ADR0) read command, an address (ADR1) read command, a write command of data (D2) to an address (ADR2), and a write command of data (D3) to an address (ADR3), from the CPU 100 to the memory control device 110, are performed continuously.

Here also, an explanation is given focusing on differences from the normal performance mode.

In the normal performance mode, at t6 in FIG. 3, when data indicating ADR1 is obtained, the CPU performance controller 111 immediately outputs the DATAACK signal, and also outputs the data “D1” obtained by the DATA signal.

However, in the reduced performance mode in which a wait is inserted into the DATAACKX, a prescribed wait period, from completion of the DATAACK signal the previous time (t1 in FIG. 5), is secured, and the DATAACKX signal is outputted (t2 in FIG. 5).

In the same way, also in cases in which output of data D2 and data D3 is ready, the CPU performance controller 111 does not immediately output the DATAACKX signal, but ensures a prescribed wait period, and outputs the DATAACK signal (t3 and t4).

Since the CPU 100 is in a waiting state until the DATAACKX signal is returned, the performance is reduced. In this way, heat generation is curtailed, and the temperature of the CPU 100 is reduced.

Furthermore, in cases as in the present figure, the prescribed wait period can be decided according to a property of the electronic device. Moreover, the wait period may be dynamically varied according to the temperature, the temperature rise, and the like, of the CPU 100.

In addition, the wait period can be measured by providing a counter in the CPU performance controller 111 and counting the number of clock units corresponding to a prescribed wait period (Wait_cnt in the figure).

What is claimed is:

1. A controller of an electronic device comprising:
a processor; and
a bus controller that is a bus master of the processor, wherein the bus controller includes:
a mode determining section that determines mode based on a state of the processor, and
a performance controller that, for a prescribed mode, inserts a wait time in an acknowledgement signal to be output to the processor.

2. A bus controller that is a bus master of a processor, the bus controller comprising:
a mode determining section that determines mode based on a state of the processor; and
a performance controller that, for a prescribed mode, inserts a wait time in an acknowledgement signal to be output to the processor.

3. A bus controller according to claim 2, wherein the mode that is determined is a mode related to temperature of the processor, and the prescribed mode is a mode indicating that the temperature has become high.

4. A bus controller according to claim 2, wherein the acknowledgement signal comprises at least one of an address acknowledgement signal and a data acknowledgement signal.

5. A printer controller that outputs image data to a print engine, the controller comprising:
a central processing unit ; and
a memory control device that is a bus master of the central processing unit, wherein the memory control device includes:
a mode determining section that determines mode in accordance with a temperature state of the central processing unit; and
a performance controller that, for a mode indicating that the temperature state of the central processing unit is high, inserts a wait time in an acknowledgement signal to be output to the central processing unit.

6. A printer controller according to claim 5, wherein the wait time is at least within a time in which the central processing unit can generate the image data that is requested by the print engine.

7. A printer in which the printer controller according to claim 5 is installed.
